(19) United States
(12) Patent Application Publication
(10) Pub. No.: US 2004/0211601 A1
(43) Pub. Date: Oct. 28, 2004

(54) Input device for a computer

(76) Inventor: Kaczmarek Allan, Nordborg (DK)

Correspondence Address: James C Wray, Suite 300, 1493 Chain Bridge Road, McLean, VA, 22101, US

(21) Appl. No.: 10/479,867

(22) PCT Filed: Jun. 6, 2002
(86) PCT No.: PCT/DK02/00383

(30) Foreign Application Priority Data
Jun. 6, 2001 (DK) PA 2001-00877

(51) Int. Cl. G06K 11/06

(52) U.S. Cl. 178/18.01

(57) ABSTRACT

By computer work the operator has to move the hand many times a day for placing the cursor correctly on the computer display by means of a pointer tool with consequent possible tensions in wrist, shoulder, neck etc, which can result in the commonly denoted “mouse injuries”. For counteracting said “mouse injuries”, a pointer tool for a computer appears in pad-shape and as a flattish body. A touch-sensitive plate is placed close to the front end of the flattish body for manipulating a cursor on a computer screen. A scroll function and at least two ergonomically suitably shaped pushbuttons are disposed in an ergonomically suitable way on the flattish body around the touch- sensitive plate. Simultaneous manual operation of all functions are enabled with minimal movements of the user's fingers. The pointer tool includes an ergonomic wrist support at the rear edge of the flattish body.

The present invention concerns a pointer tool for use together with a computer and a screen connected thereto, and where the pointer tool is disposed externally in relation to the computer on a surface, e.g. a work table, and comprising a first kind of manually operation means which, together with resident software in a computer to which the pointer is connected via an interface, changes the position of a cursor displayed on the screen, and a number of a second kind of manually operational means for executing different operations with computer resident software to which the pointer is connected via an interface, changes the position of a cursor displayed on the screen, and a number of a second kind of manually operational means for executing different operations with computer resident software, and that the pointer tool is in the shape of a pad and appears as a flattish body with relatively great length/width dimensions relative to the thickness of the body, and where the flattish body has a front end and a rear end, and where the first kind of manually operational means is constituted by a touch-sensitive plate are situated close to the front end of the flattish body.

Such pointer tools are known as the traditional and colloquially called “computer mouse”, or pointing device of which a wide range of various forms are known, for the purpose of achieving a good ergonomic work position in connection with operating the mouse.

The ergonomically good work position is very important for the user since the continuously increasing extension of computers containing resident software performing different operations according to the principle of “point and click” implies increasing use of the said pointer tools, and because the lack of a good working position will result in absence due to illness and wearing down of those operating a computer in a bad working position.

Typically, the hitherto known computer mice comprise a cabinet upon which the user places the hand, and displacing of the cabinet over a surface will, as a consequence of position sensors in connection with a ball rolling on the said surface, cause displacement of the cursor on the computer display. At the top side of the cabinet there are typically two to three pushbuttons for executing different operations with the computer resident software. The cabinet can also include a scroll-wheel for “rolling” down an image or text shown on the computer display.

In addition, there are known pointer tools in the shape of a touch-sensitive plate, popularly called “GlidePoint”, which typically has become very popular as integrated pointer tool in portable computers, since thereby one avoids connecting an external computer mouse every time the computer is used. However, the said integrated pointer tools on portable computers are rarely disposed in an ergonomically suitable way relative to pushbuttons for executing operation with computer resident software, and the position of the scroll function is typically not placed suitably in relation to the touch-sensitive plate and the push-buttons.

From EP 0 905 645 A1 there is known a reader device for reading letter and numerical data into a flight computer program, comprising a cursor control device and a rotatable button situated within finger distance from the cursor control, so that the user is able to perform operations with the device by moving the fingers only. The reader device is formed with a strongly inclining surface and comprises a wrist support at the upright free end. The physical design of the device very likely presents suitable conditions with respect to ergonomically suitable operating conditions, when the device is situated in an airplane, e.g. at the end of an arm rest or the like, but does not present any particularly suitable ergonomic conditions of use if it is placed on a common plane work table with the object of application as pointer tool like the prior art computer mice.

From WO 98/43202 is known a button wheel pointing device for notebook PCs, comprising a pointing function, a click button function and a scrolling and zoom function. The pointing function is provided by a pointing device such as a touch pad or a trackball built into a data entry surface of the input device. The click button function is provided by one or more click buttons disposed on a front end of the input device adjacent the data entry surface. The scrolling and zoom functions are provided by a wheel, roller bar, or buttons disposed adjacent to the pointing device. The pointing device, click buttons and scrolling/zooming device are operable by a users thumb or finger such that the user may perform an combination of the functions simultaneously, quickly, comfortable and with a minimum of effort and hand movement. However, it should be noticed that this pointing device primarily is suited for notebook PCs, for building into normally keyboards for normal PCs, or as an external pointing unit, and thus, the pointing device according to this invention lacks the field of ergonomically correct design and in connection therewith, serious considerations concerning the mutual location of the click buttons and the scrolling and zoom functions and the glide point. In connection with notebook PCs and integrating a pointing device in a normal keyboard, it is crucial to save space, thus the horizontal extent of such pointing devices are minimized. Said minimalization leaves some limitations concerning the design possibilities, especially when the pointing device comprises a touch pad, which takes up practically the whole breadth of the space for the location for said device on a notebook PC, or on a keyboard. Typically this will cause a location of the click buttons and the scrolling or zoom function in the front or rear the longest centre axis of the touch pad, and further, inside a space limited by an elongation of the lines defining short the sides of the rectangular touch pad. This will result in a non ergonomic hand position, when using the pointing device, since the distance of the buttons and scroll/zoom function are so small, that the performing simultaneous operations with the pointing device will require the user to crumble the operating hand, to reach and operate said functions on the pointing device. Said crumbling will after working a whole day imply tensions in wrist, shoulder, neck etc., which over time may lead to mouse injuries. The pointing device known from WO 98/43202 is thus not suited for long term use day after day, e.g. for draftsmen, or other users of PCs with a large need of performing “point and click”functions with resident software in the PC. Fortunately the use of notebook pointing devices, are relative limited, as the most users of notebook PCs most frequently have access to traditional pointing devices, such as a computer mouse, trackballs, with a more suitable ergonomic shape.

With the purpose of achieving an ergonomically good work position when using a computer mouse, it is known to use a “mouse plate”, which typically along one side edge is provided with a wrist support with the intention of avoiding a rearwards extension of the user's wrist, possibly causing tensions in his forearm, shoulder and neck. The said kind of mouse plate has also appeared to have a certain effect, but the number of mouse injuries on persons mainly using a computer mouse for daily work is largely unchanged.

Particularly people within the graphic industry and draughtsmen are very dependent on using a pointer tool which hitherto has been constituted by the traditional computer mouse, however in different ergonomically suitable forms. The traditional computer mouse includes, as already mentioned, typically no more than three pushbuttons for executing functions in the computer resident software, but the need for using more pushbuttons is very expressed in connection with drawing and graphic work, where many short cut key operations are used. This means that the operator many times a day has to move the hand between the mouse and the computer keyboard. Furthermore, the wrist is to control the movement by using traditional computer mice, which after working a whole day implies tensions in wrist, shoulder, neck etc., which over time may lead to mouse injuries.

It is the object of the invention to indicate a pointer tool of the kind indicated which is particularly suited in connection with computer work, where operating the functions in the resident software mainly occurs via the pointer tool, and which also implies an ergonomically good work position for the user.

This object is achieved with a pointer tool of the indicated kind which is characterised in that at least two of the second kind of manually operational means are situated beside and close to the first kind of manually operational means on the flattish body for enabling simultaneous manual operation of the first kind of the manually operational means and the second kind of manually operational means, respectively.

The advantage of the new pointer tool according to the invention is that manipulating with the cursor occurs by means of the first kind of manually operational means (the touch sensitive plate), typically by the operator's forefinger, whereby the wrist is not strained. By the suitable mutual positioning of the second type of manually operational means “right at hand”—or, more correctly, at the fingers, relative to the first kind of manually operational means, there is also achieved an ergonomically suitable work position for the user so that manipulation with the cursor on the computer display and execution of different work operations with the computer resident software can be performed without moving the wrist at all.

The pointer tool according to the invention many furthermore advantageously be provided with a scroll function disposed close to the first kind of manually operational means, whereby visualisation of/flipping through the computer display image may be considerably facilitated, again without unnecessary wrist movements.

With the purpose of facilitating operation of the scroll function, which typically is constituted by a wheel, it may, however without abandoning other embodiments of the scroll function, be noted that a particularly preferred embodiment of the scroll function may be constituted by a four point switch for visualizing a screen image in horizontal as well as vertical direction.

The second type of manually operational means for executing operations in computer resident software may advantageously be constituted by pushbuttons with at least one switch function, or groups of the same, with an ergonomically suitable form and mutual position on the flattish body in relation to the first kind of manually operational means for changing the position of a cursor shown on the computer screen and to the scroll function.

The number of pushbuttons on the pointer tool according to the invention does not need to be greater than the number in a common computer mouse, namely three, but it is preferred that the pointer tool is equipped with a group of pushbuttons opposite the thumb, the ring finger and the little finger. In this connection is to be mentioned that when speaking of ergonomically suitable shape and positioning of the pushbuttons in connection with the pointer tool, this is to be understood in this way that the buttons are disposed for operation in connection with the pointer tool with the above fingers, are shaped according to the anatomy and patterns of movement of respective fingers when a hand for operating the pointer tool is placed with the wrist at the rear edge of the flattish body, and the placing of the pushbuttons shaped ergonomically suitably on the flattish body is determined under the greatest possible consideration of the patterns of movement of the fingers in the operational position.

In special cases, the pushbuttons, or groups of these, may be constituted by four point switches, typically with a switch function at each end, which may be advantageous if the pointer tool is used in connection with software to which is associated many short cut operations used often.

The possibly increased number of pushbuttons on the pointer tool in connection with an associated “driver” (software) opens the possibility of dedicating individual buttons in respective groups for different short cut key combinations in relevant computer resident software, whereby the operator avoids moving the hand away from the pointer tool when performing a large number of routine operations whereby injuries resulting from muscular tensions etc. at the operation of the pointer tool are counteracted.

With the intention of enabling compensation of the position of the pushbuttons relative to the position of the touch-sensitive plate and the scroll-wheel, in case of change of user of the pointer tool, where it may be expected that a new user has another hand size/finger length, width, pushbuttons or groups hereof may be detachably attached and embedded displacing in the flattish body. Hereby is achieved possibility of compensating the position of the buttons in relation to the natural hand size and finger position of a given user.

For further enabling an ergonomically good position of use of the pointer tool according to the invention, this may advantageously include an ergonomically shaped wrist support at the rear end of the flattish item. Hereby is achieved that the wrist is elevated in level with the top side of the flattish body, whereby a backwards directed twist of the wrist for the user of the pointer tool is eliminated.

The ergonomically shaped wrist support may furthermore be detachably attached and embedded so that it is displaceable in parallel with the rear end of the flattish body, whereby there is possibility of individual positioning of the wrist support.

The wrist support may furthermore advantageously include a top side consisting of soft silicon rubber, or a correspondingly soft mass which moreover may be individually workable. Hereby is achieved possibility of a comfortable rest position for the wrist during operation of the pointer tool, and in case of the user's need, individual adaptation of the surface of the wrist support will even be possible, so that is fits accurately to the user's hand.

Furthermore it is to be mentioned that the interface used for connecting the pointer tool according to the invention may be constituted by any known way of connection, e.g. traditional cable connection, a wireless connection, e.g. an IR-connection, or a way of connecting suited for the purpose.

With the intention of attaining as universal utilisation of the pointer tool as possible, this may be adapted with accompanying software so that the first kind of manually operational means and the second kind of manually operational means and the four point switch of the scroll function may be configured to execute different operations with computer resident software. This has the consequence that any of the operational means may be dedicated to any relevant function in the computer resident software.

The invention is explained more closely in the following with reference to the drawing, where:

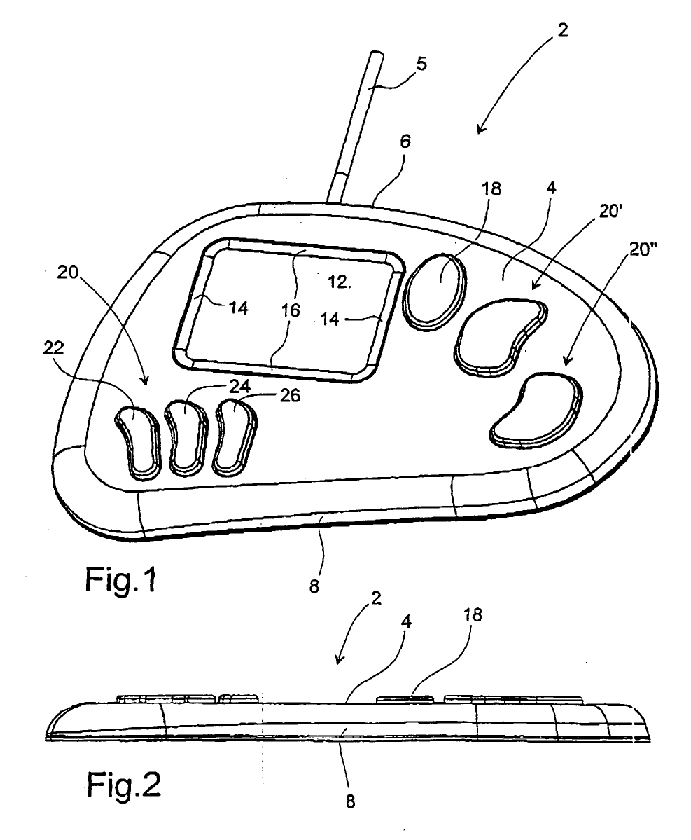

FIG. 1 is a perspective view from behind of the pointer tool for a computer according to the invention,

FIG. 2 is a view from the rear edge of the pointer tool shown in FIG. 1,

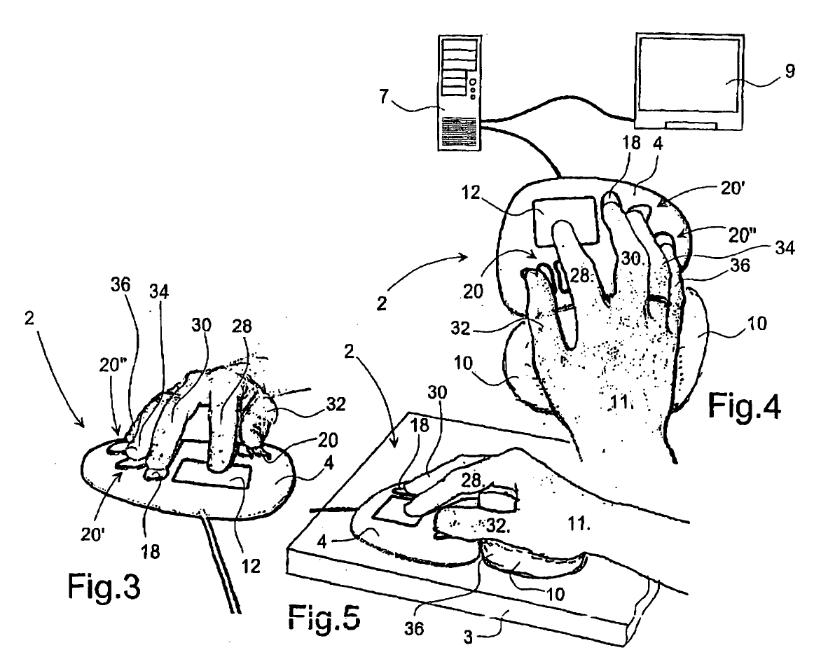

FIG. 3 is a perspective view from the front edge of the pointer tool shown in FIG. 1 with a user's hand placed in the position of use upon the pointer tool,

FIG. 4 shows the same as FIG. 3 but from above, and where the pointer tool furthermore comprises a wrist support, and where the pointer tool in schematic form is shown connected to a computer, and

FIG. 5 is a side view of the items shown in FIG. 4.

FIG. 1 shows a perspective view of an embodiment of the pointer tool 2 according to the invention. The pointer tool is connected to a computer 7 in a known way by a cable connection 5, cf. FIG. 4. It is to be noted that all other relevant ways of connecting are possible, e.g. via a wireless connection (IR).

In the shown embodiment of the pointer tool 2 according to the invention, this appears in pad-dorm as a flattish body 4 with a relatively great length/width compared with the thickness of the body, cf. FIG. 2. The body has a front end 6 and a rear end 8, where an ergonomically shaped wrist support 10 can be found close to the rear end 8, cf. FIGS. 4 and 5. The wrist support 10 may be constituted by a gel pad, soft foam plastic, neoprene rubber or similar yielding material or corresponding material which is individually workable and intended for the placing the user's wrist 11, cf. FIGS. 4 and 5, with fingers oriented towards the front end 6 of the base plate.

Close to the front end 6, the first kind of manually operational means are provided in the shape of a touch-sensitive plate 12, which in the shown embodiment of the pointer tool 2 according to the invention appears as a rectangular plate with parallel short sides 14 and long sides 16 extending in parallel. The technique behind the touch-sensitive plate is well-known and is thus not discussed any further. The touch-sensitive plate 12 is situated so that the user's forefinger 28 is substantially placed at the centre of the touch-sensitive plate 12 by placing the heel 9 of the hand on the ergonomic wrist support 10 or behind the rear edge of the flattish body 2.

Close to one short side 14 of the touch-sensitive plate 12 and closest to the long side 16 facing the front end 6 of the base plate there is a scroll function 18, which in the shown embodiment of the pointer tool is presented as a pushbutton 18, typically comprising a four point switch for visualising an image displayed on the computer screen 9 in horizontal as well as vertical direction. In a not shown embodiment, the switch for the scroll function can be constituted by a traditional scroll wheel. The scroll function 18 is intended for being operated with the long finger 30 of the user, when the user's wrist is placed at or close to the rear edge 8 of the flattish body.

On the base plate 4 there are furthermore three groups 20, 20′, 20″ of ergonomically shaped pushbuttons for executing various operations associated therewith with the computer resident software. In the shown embodiment of the pointer tool it appears that the group 20 consists of three ergonomically shaped buttons 22, 24, 26, which, as it appears from FIGS. 3, 4 and 5, are intended for operation with the user's thumb 32. “The groups” 20′, 20″ appear in the shown embodiment of the pointer tool as single buttons, but these buttons may have two or more switch functions (not shown) which may be dedicated to executing relevant operations with the computer resident software, depending on which embodiment of the pointer tool we are speaking of, as well as the groups 20′, 20″ may comprise a plurality of keys, e.g. like the group 20.

Thus the group 20 is placed at the top side of the flattish body 4 and relative to the touch-sensitive plate 12 and the scroll wheel 18 so that it lies naturally for operation by thumb 32 of the user, and the groups 20′ and 20″ lie naturally for operation by the ring finger 34 and little finger 36, respectively, when the user's heel 11 of the hand is placed on the ergonomic hand rest 10.

It is to be mentioned that the pushbuttons 22, 24, 26 and the groups (the pushbuttons in the shown embodiment) 20′,20″ are ergonomically shaped compared with the structure of a hand. The pushbuttons 22, 24, 26 are, as seen in FIG. 1 et al, designed with different shapes, and the mutual disposition of these is very carefully determined with regard to the expectation that the user will operate these pushbuttons with the thumb 32 with a minimum of movement. Furthermore, the groups (the pushbuttons in the shown embodiment) 20′,20″ are placed suitably relative to the touch-sensitive plate 12 and the scroll function 18, so that all functions can be operated by the user while exerting minimal movement. Furthermore, as it is seen, the pushbuttons 20′, 20″ are designed with different shapes due to the fact that in connection with the designing of these consideration is made with regard to the pattern of movement of the relevant fingers, which are intended for operating these, in the embodiment shown the ring finger 34 and the little finger 36.

The height of the pushbuttons 22, 24, 26, 20′, 20″ is furthermore relatively small, whereby the distance between the top sides of the buttons and the surface of the touch-sensitive plate becomes relative small, contributing to prevention of tensions in the user's hand.

FIG. 3 is a view of the front side of the pointer tool 2 where a user's hand is placed with the fingers on relevant pushbuttons 20′, 20″, 22, 24, 26. It is noted that it will be possible for the user to operate the touch-sensitive plate 12 with the forefinger 28 simultaneously with the scroll function 18 being operated with the long finger 30 and the pushbuttons with the thumb 32, the ring finger 34 and the little finger 36, respectively.

FIGS. 4 and 5 are a top view and a side view, respectively, of the pointer tool 2 shown in FIG. 3 with the user's hand placed with the fingers on relevant pushbuttons 20′, 20″, 22, 24, 26, the scroll function 18 and the touch-sensitive plate 12, and where a wrist support 10 is found at the rear side edge 8 of the flattish body 4. The wrist support 10 may in a known way be fastened to the rear edge 8 of the flattish body 4 or be fastened so that the side 36 facing the rear edge 8 can be displaced along the rear edge 8, and, if necessary, be fastened at a position chosen by the user.

Finally, it is to be mentioned that the inventor has realised that the pointer tool according to the invention can assume other shapes that the shown embodiment, but this does not change the basic inventive idea consisting of combining pointer means, scrolling facilities and pushbuttons known per se, which are used traditionally in other connection in a less ergonomically suitable way such as is the case with portable PC's with touch-sensitive plate, pushbuttons and scroll function, which are here disposed more or less randomly for space reasons, into one and the same external unit, and where the said functions are here designed and placed on a flattish body in way which is ergonomically suited for the user.

1. A pointer tool for use together with a computer and a screen connected thereto, and where the pointer tool is disposed externally in relation to this on a surface, e.g. a work table, and comprising a first kind of manually operational means which, together with resident software in a computer to which the pointer is connected via an interface, changes the position of a cursor displayed on the screen, and a number of a second kind of manually operational means for executing different operations with computer resident software, and that the pointer tool is in the shape of a pad and appears as a flattish body with relatively great length/width dimensions relative to the thickness of the body, and where the flattish body has a front end and a rear end, and where the first kind of manually operational means is constituted by a touch-sensitive plate are situated close to the front end of the flattish body wherein at least two of the second kind of manually operational means are situated beside and close to the first kind of manually operational means on the flattish body for enabling simultaneous manual operation of the first kind of the manually operational means and the second kind of manually operational means, respectively.

2. A pointer tool according to claim 1, wherein beside the first kind of operational means and close to this there is a scroll function.

3. A pointer tool according to claim 2, wherein for visualizing a screen display in horizontal as well as vertical direction on a screen connected to the computer, the scroll function is constituted by a four point switch.

4. A pointer tool according to claim 1, wherein the second kind of manually operational means are constituted by pushbuttons with at least one switch function, or groups of same with an ergonomically suitable shape.

5. A pointer tool according to claim 4, wherein the pushbuttons or the groups of same are constituted by four point switches, typically with a switch function at each end.

6. A pointer tool according to claim 1, wherein the second kind of manually operational means are detachably attached and embedded displacing in the flattish body.

7. A pointer tool according to claim 1, wherein it further includes an ergonomically shaped wrist support for placing at the rear end of the flattish body.

8. A pointer tool according to claim 7, wherein the wrist support is attached detachably and can be displaced in parallel with the rear end of the flattish body.

9. A pointer tool according to claim 7, wherein the wrist support includes a top side which is made up of soft rubber or of an individually workable mass.

10. A pointer tool according to claim 1, wherein the interface used for connecting the pointer tool according to the invention to the computer may be constituted by a traditional cable connection.

11. A pointer tool according to claim 1, wherein the interface used for connecting the pointer tool according to the invention to the computer is constituted by a wireless connection, e.g. an IR-connection.

12. A pointer tool according to claim 1, wherein a first kind of manually operational means and the second kind of manually operational means and the four point switch of the scroll function may be configured to execute different operations with computer resident software.
